(19) United States
(12) Patent Application Publication
(10) Pub. No.: US 2017/0295075 A1
(43) Pub. Date: Oct. 12, 2017

(54) SYSTEM FOR CONTACTING A CLIENT BASED UPON CLIENT DEVICE ANALYSIS

(71) Applicant: HRB Innovations, Inc., Las Vegas, NV (US)

(72) Inventor: Eric R. Roebuck, Shawnee, KS (US)

(21) Appl. No.: 15/095,897

(22) Filed: Apr. 11, 2016

(51) Int. Cl. H04L 12/26; H04L 29/08

(52) U.S. Cl. CPC H04L 43/04; H04L 43/08; H04L 67/22

(57) ABSTRACT

Client communication is dependent on a client device and client attributes. A computerized method includes the following steps: acquiring a set of behavioral information; acquiring a set of client device information; determining a set of recommended attributes for a communication strategy based upon the sets of client and device information; implementing the communication strategy by sending a first client inquiry to the client via the client device, wherein the first client inquiry is based at least in part on the set of recommended attributes of the communication strategy; analyzing a client response to the first client inquiry; refining, based upon the client response to the client inquiry, the set of recommended attributes to form a set of revised attributes; and sending a second client inquiry to the client via the client device, wherein the second client inquiry is based upon the set of revised attributes.

### BACKGROUND

### 1. Field

Embodiments of the invention are broadly directed to the fields of client inquiries and interviews.

### 2. Related Art

Various persons and organizations need to present inquiries to others, such as clients. These inquiries can be very time consuming, and require the clients undivided attention for the duration. Finding a time that is convenient for both the client and the inquirer can be difficult. What is lacking in the prior art is a system for determining how, when, and where to present inquiries to the customer in a convenient and efficient manner.

These questions are typically simple, easy-to-understand and easy-to-answer questions. Nonetheless, these questions need to be answered to allow the inquirer to successfully and accurately perform a service. These interviews of the prior art therefore present several problems. First, the interview of the prior art can be quite lengthy, depending on the complexity of the service. Finding time to complete the interview is therefore difficult. Second, the interview of the prior art requires the exclusion of other tasks during the completion. This limits the available time in which the interview can be conducted, as the total necessary time must be set aside before beginning the process. Third, certain interviews require that the client be in a certain location, such as in an office of the inquirer or in their home office dedicated to the performance of the service.

### SUMMARY

Embodiments of the invention solve the above-mentioned problems by providing a client inquiry system that is convenient for both the inquirer and the client. The system monitors the activities of the client to determine locations and times that would be most convenient for the client to answer questions. The system also divides up the inquiries into conveniently sized sets of inquiries and presents the set of inquiries to the client and the time and location determined. Based upon the answers provided, certain additional questions may be added or removed. If the client did not respond, the system may revise certain attributes of the communication strategy and then attempt new communication.

A first embodiment of the invention is broadly directed to a computerized method for gathering information from a client, the method comprising the following steps: acquiring a set of behavioral information; acquiring a set of device information related to a client device associated with the client; determining a set of recommended attributes for a communication strategy based upon said set of behavioral information and said set of device information; implementing the communication strategy by sending a first client inquiry to the client via the client device, wherein the first client inquiry is based at least in part on the set of recommended attributes of the communication strategy; analyzing a client response to the first client inquiry; refining, based upon the client response to the client inquiry, the set of recommended attributes to form a set of revised attributes; and sending a second client inquiry to the client via the client device, wherein the second client inquiry is based upon the set of revised attributes.

A second embodiment of the invention is broadly directed to a client inquiry system, comprising a predictive engine, an implementation engine, and a responsive engine. The predictive engine develops a set of recommended attributes for a communication strategy. The implementation engine sends a first client inquiry to the client via a client device. The first client inquiry is based at least in part on the set of recommended attributes of the communication strategy. The responsive engine analyzes whether the client responded to the first client inquiry and refining the set of recommended attributes to form a set of revised attributes. The set of revised attributes is configured to improve client responses. The implementation engine sends a second client inquiry based at least in part on the set of revised attributes.

A third embodiment of the invention is broadly directed to a client inquiry system comprising a predictive engine, an implementation engine, and a responsive engine. The predictive engine is configured to perform steps including—acquiring a set of behavioral information; acquiring a set of device information related to a client device associated with the client; and determining a set of recommended attributes for a communication strategy based upon said set of behavioral information and said set of device information. The implementation engine is configured to perform steps including—sending a first client inquiry to the client via the client device, wherein the first client inquiry is based at least in part on the set of recommended attributes of the communication strategy; and analyzing a client response to the first client inquiry. The responsive engine is configured to perform steps including—refining, based upon the client response to the client inquiry, the set of recommended attributes to form a set of revised attributes; sending the set of revised attributes to the implementation engine. The implementation engine sends a second client inquiry to the client via the client device, wherein the second client inquiry is based upon the set of revised attributes.

Still other embodiments of the invention are directed to a non-transitory computer readable medium having a computer program stored thereon. At least one processing element instructs the computer program to perform the steps discussed in this disclosure.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 is a flow diagram illustrating a client inquiry system generates a communication strategy, implements the strategy, and revises the strategy;

FIG. 2 is a flow diagram illustrating a predictive engine that generates the communication strategy based upon client and device information;

FIG. 3 is a flow diagram illustrating an implementation engine that presents inquiries to the client based upon the communication strategy; and

FIG. 4 is a system hardware diagram illustrating the various hardware components of an embodiment of the invention.

The drawing figures do not limit embodiments the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

The invention provides various embodiments of a computer program, a method, and a system for developing, implementing, and refining a communication strategy with a client. The communication strategy includes at least one client inquiry. The client inquiry is a small and convenient set of questions for the client. The client inquiry comprises a set of attributes. The set of attributes may include questions to be presented to the client, the form in which the questions will be asked, when the questions will be asked, how the questions will be asked, how the client will respond, etc. The client inquiry receives responses from the client. Based upon the response or lack of response from the client, the attributes of the client inquiry may remain the same, may be modified, or may be changed. In this way, additional client inquiries in the communication strategy will be improved and more likely to receive positive responses from the client. As such, the communication strategy can take place over an extended period of time and require minimal time and attention commitments from the client.

Most of the following detailed description is broadly directed to the taxation field as an exemplary field of use for the invention, although it should be appreciated that embodiments of the invention may be used in any industry, field, or market. In the taxation field, the client is often a client, a taxpayer, or a person on behalf of the taxpayer. It should be appreciated, however, that this is only an exemplary use that should not be construed as limiting on the invention. Therefore, throughout this description the terms “client,” “client,” and “taxpayer” are used interchangeably. Similarly, the terms “inquirer” and “tax professional” are used interchangeably.

A “taxpayer” includes any entity, either a legal or natural person, that files a tax return with a government taxing authority. The taxpayer may also be a first spouse and a second spouse filing a joint return. The client may therefore be a representative, officer, agent, employee, or other person associated with the taxpayer. Taxes to be paid can be United States Federal Income Tax, income tax for the various states within the United States, corporate taxes, partnership taxes, LLC taxes, property taxes, tariffs, or other taxes. Typically, the taxpayer provides information relevant to themselves and the amount of tax owed in the tax interview.

In embodiments of the invention, the “inquirer” is a tax professional. The tax professional includes any entity, either a legal person or natural person, or a computer program adapted to preparing taxes or providing other financial services. Examples of tax professionals include, but are not limited to, the following: a company, such as H&R Block, Inc.®, or an employee or agent of such a company; software adapted to prepare tax returns or other financial documents; and a person, legal or natural, who advises or assists the taxpayer in preparing their own tax return. The tax professional may also comprise a database for storing of tax related documents.

In the exemplary field of tax, the client inquiry may be a tax interview associated with the preparation of a tax return. The tax return is essentially a report filed with the appropriate government taxing authority, such as the IRS in the case of U.S. federal income tax. Typically, the tax return contains information used to calculate the tax due. Typically, the tax return is either printed or hand-written on a form generated by the taxing authority, such as the Form 1040. On the tax return, the tax professional calculates the taxes due. The tax interview therefore provides the tax professional with the information needed to perform these calculations. To assist in the calculation and to allow the taxing authority to verify the calculations, the tax return contains pertinent information associated with the taxpayer for the tax period. The tax return can be either written, digital, or a combination of both. In other embodiments, information relevant to the taxpayer and the tax to be paid are provided on other various forms and documents.

Tax returns are typically due in a tax return filing season following the tax year. A tax year is typically a calendar or fiscal year upon which the tax is calculated. A tax period may be another length of upon which the tax is calculated, such as a month, a quarter, half of a year, two years, five years, etc. The tax interview is typically conducted during the return filing season. This is because many of the answers to the questions do not become finalized until after the close of the tax year. For example, if the inquiry asks if the taxpayer has purchased a house during the tax year, this questions can only be answered definitively after the tax year is closed (as the taxpayer may purchase a house at the end of the tax year). Some questions may also be prospective, such as “do you expect to have any additional dependents during this tax season.”

Other embodiments of the invention may be directed to other fields. For example, one embodiment of the invention may be broadly directed to the medical field. In the medical field is typical for the clinic or hospital or clinic to have various introductory or background questions that the client should answer before the appointment begins. Typically, in the prior art, the patient would answer these questions in a questionnaire upon arrival or during a conversation with a nurse before meeting with the doctor. This is a time consuming and laborious process. Therefore, in embodiments of the invention, the client inquiry system contacts the client (which is the patient) in the days or weeks before their appointment to ask the patient these background and introductory questions. In this way, the patient's time in the clinic or hospital is spent efficiently.

Yet another example of the field of the invention could be in commercial sales. The client is a customer or potential customer. The client may set an appointment with a real estate agent or car salesman. Then, in the days leading up to the appointment, the client inquiry system may contact the potential customer with inquiries about the certain features, prices, and other considerations for their purchase. Then, when the potential customer arrives at their appointment, the real estate agent or car salesman already know what the potential customer is looking for and can begin recommending or showing certain products sooner. This provides for a streamlined and simplified in-person process.

Yet a further example of the field of the invention could be in finance and loans. The client is a potential customer that may be applying for a loan, a mortgage, or other financial product. The client inquiry system may contact the potential customer to ask questions necessary to determine whether the potential customer qualifies for the financial product, what terms are appropriate for the client, and to complete the paperwork to accompany the application. Then, when the potential customer has completed the interview, the completed application may be submitted to the potential customer for signature or an in-person appointment may be held to finalize the application.

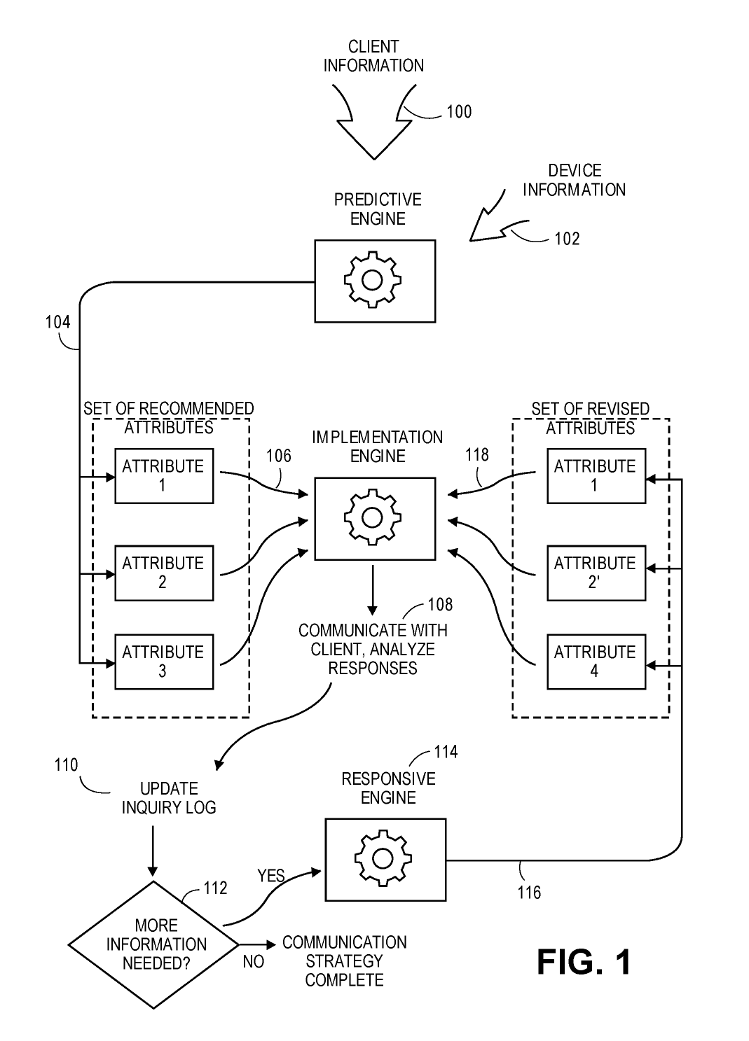

Turning to the figures, FIG. 1 is broadly directed to an exemplary embodiment of a convenient client inquiry system, including a system dependent on a client device. FIG. 1 broadly creates a communication strategy designed to successfully contact and receive information from the client, presents the communication strategy to the client, monitors the client's progress and responses, and adapts the communication strategy to better meet the client's needs. In Step 100, the predictive engine receives behavioral information, indicative of the type of client that will be the recipient of the communication strategy. In Step 102, the predictive engine receives device information indicative of at least one client device that the client will utilize in association with the communication strategy. Based upon this information, in Step 104, the predictive engine draws on an attribute pool to determine a set of recommended attributes for the communication strategy. As illustrated, the set of recommended attributes includes “Attribute 1,” “Attribute 2,” and “Attribute 3.” Examples of attributes include when to contact the client, where to contact the client, how to contact the client, what questions to present, how to receive answers, and the like.

The set of recommended attributes is then input to the implementation engine in Step 106. In Step 108, the implementation engine begins contacting the client to present the client inquiries. Responses (or lack thereof) are then analyzed. In Step 110, the answers or other information provided by the client are added to an inquiry log. The inquiry log tracks the questions asked, answered received, and additional information needed from the inquiry (which may be influenced by the other answers received). In Step 112, the implementation engine determines whether more information is needed. Additional information may be needed based upon the original communication strategy, the responses received, newly requested information, or the like. If no additional information is needed, the communication strategy is determined to be complete and the iterations are terminated.

If additional information is needed, information regarding the responses (or lack thereof) are provided to a responsive engine in Step 114. The responsive engine analyzes the responses to determine whether future iterations of contacting the client should follow the same communication strategy, or whether the attributes of the communication strategy should be revised to attempt more successful responses. In Step 116, the responsive engine develops a set of revised communication strategies. As illustrated, the set of revised attributes includes “Attribute 1” (i.e. an unchanged attribute from the set of recommended attributes), “Attribute 2” (i.e. “two prime” shown in FIG. 1, which is a revised or altered attribute from the set of recommended attributes), and “Attribute 4” (i.e. a new attribute not originally in the set of recommended attributes). The set of revised attributes is returned to the implementation engine in Step 118. The revised communication strategy is then again utilized to contact the client. The communication strategy therefore is repeatedly updated and revised to improve the interaction level with the client.

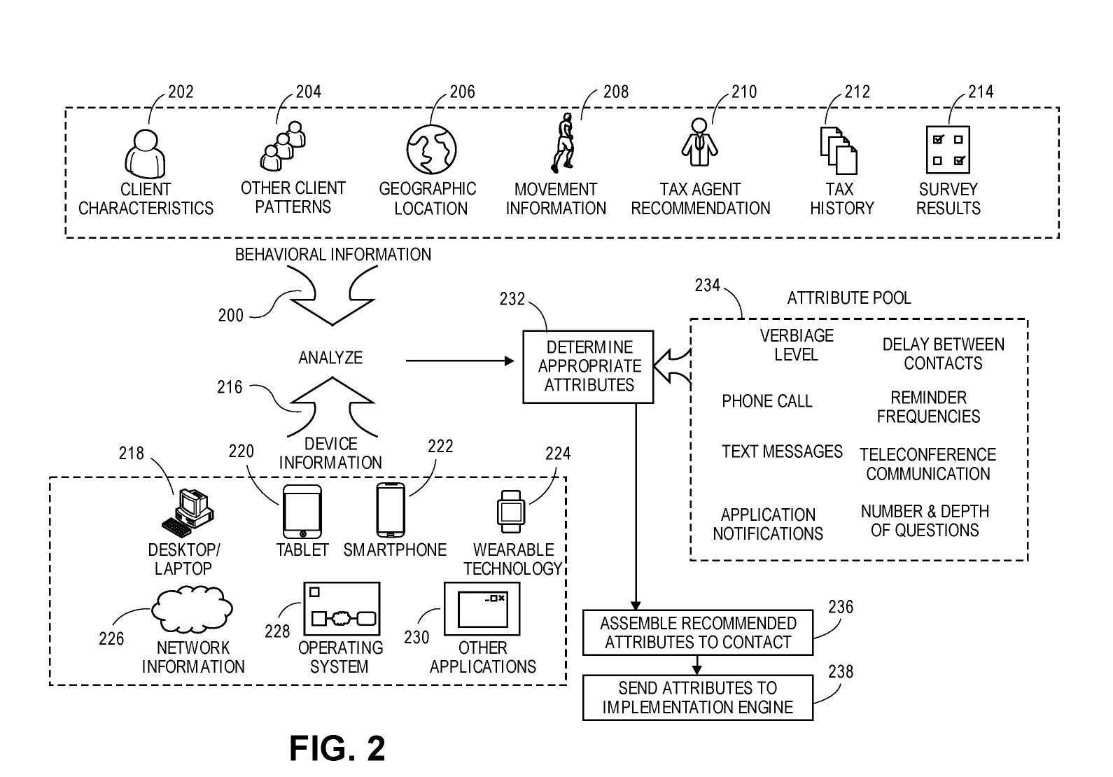

FIG. 2 is generally directed to steps performed by the predictive engine, including the creation and organization of the communication strategy based upon certain attributes. As discussed above, a common problem of client inquiry systems of the prior art is that they are not customized to the specific client, they require a large amount of uninterrupted time and effort, and they are not convenient for the client. It should be noted that FIG. 2 is expressed in terms of the tax field, but it is equally applicable to other fields.

The creation of the communication strategy begins in Step 200 with the analysis of available behavioral information. As described below, the behavioral information includes a portion, substantially all, or all available information about the client such that the communication strategy can be tailored to the client. It should be appreciated that some behavioral information is available at the onset of Step 200. For example, client characteristics and demographics are fixed and generally known at the beginning of the process. Other behavioral information may be gathered over time as the predictive engine gathers information about the geographic location and movements of the client. For example, in some embodiments of the invention, the creation of the communication strategy may be performed over a prolonged period of time (such as a day, a few days, a week, or a few weeks), such that the predictive engine can gather information about the movements and activities of the client.

In Step 202, the behavioral information includes client characteristics, such as age, gender, and family composition. The client characteristics may be derived from a client account. The client characteristics may also include demographics of the client such as socio-economic class, race, marital status, parenthood, etc. Demographic information could also include an income level for the client and/or the client's household. The income level could be a numerical value or a range value. The client characteristics and the demographic information may be used to determine the optimal way in which to attempt to contact the client. For example, if the client is in their late teens or early twenties, contact via text message may be most effective. On the contrary, clients in their sixties and seventies may be most effectively reached by a phone call.

In Step 204, the behavioral information includes an analysis of patterns from other clients. The pattern analysis may look at any one or several factors to establish patterns of response or non-response based upon the various attributes of the communication strategy. For example, if the client is a police officer, the predictive engine may determine that other police officers do not answer their phones while driving in their vehicles. This is because the police officer is typically on duty during that time and thus cannot answer their phone. Conversely, if the client is a truck driver, the predictive engine may determine that other truck drivers have a very high response rate while driving their vehicle. In this way, the predictive engine can determine a communication strategy that is likely to be effective for the client by analyzing (or accesses previous analysis related to) other clients.

In Step 206, the behavioral information includes a geographic location of the client. The geographic location may include general geographic data and specific geographic data. General geographic data includes information about the client that is relatively static, such as home location, work location, and the general area in which the client lives. For example, if the client lives in New York City, their daily commute may allow them to communicate via text message (from a subway or taxi), but not allow them to communicate over a phone call (due to privacy concerns). If the client lives in a small town, their commute is more likely to be done in a car, such that a phone call may be appropriate. Similarly, if the client lives within a few miles of their work, the daily commute may be too short to facilitate communication.

The specific geographic data is typically provided by one of the client devices, as discussed below. The specific geographic data deals with where the client currently is and information known about that place. For example, if the client is at a location known to include waiting, such as a bank, clinic, hospital, or pharmacy, the predictive engine may determine that there is a high likelihood that the client would respond to a client inquiry.

As an example, the predictive engine may determine that the client is driving in his car. The software has determined that this is something the client does Monday through Friday to and from the same location and also around the same times (in this client's case, this is his commute to and from work). Since the predictive engine has determined that this is a common occurrence through pattern analysis, and that the client is in his car, the predictive engine determines that an attribute that phone calls during this time may be effective (as opposed to a text or email). One day, the implementation engine calls to ask the client questions. The client receives a phone call and an automated voice representing the tax professional asks: “Do you have any dependents?” The client answers affirmatively. The implementation acknowledges and responds by asking the client “Did you have any child care expenses for these dependents?” The client again answers affirmatively. The implementation engine acknowledges and responds by asking “Did these children live with you for more than 6 months?” The client again answers affirmatively. The automated voice then thanks the client, hangs up, and determines that this was a successful communication method and time with the client.

As another example, the predictive engine may determine that the client drives to the same location at approximately the same time on every Tuesday night. The predictive engine may recommend an attribute of calling the client during that travel. However, the client is driving a child to soccer practice and as such does not answer the phone call. The predictive engine may also determine that the location to which the client is driving is a child's soccer location. The predictive engine may then recommend an attribute of sending a text message to the client while the client is watching the child play soccer. The client responds as this is a minimal distraction and not invasive.

The geographic location could also include information regarding nearby tax professionals, financial professionals, system administrators, and the like (along with the corresponding distances between such locations and the client's current location, residence, and/or work place). If in-person functions are necessary, such as the signing of documents, the provision of documents, or in response to a client request for in-person assistance, the predictive engine may inform the client that they are near a location associated with the tax professional. This allows the client to have an option to travel to the location at minimal inconvenience.

In Step 208, the behavioral information includes movement and activity information for the client. For example, an accelerometer in the smart phone may provide an indication of the current activities of the client. A step counter may determine that the client is likely taking a long walk. The predictive engine may determine that the walk is a good time to contact the client, and recommends an attribute to call the client at that time. As another example, the step counter may determine that the client is going on a long run, the predictive engine may determine that the run is a bad time to call the client, and as such not recommend attributes of calling or texting during a run.

As another example, the accelerometer in a smart phone may be able to determine when the client is holding or carrying the smart phone (as opposed to the smart phone sitting idly). The predictive engine may therefore recommend attributes to contact the client while the client is holding or carrying their smart phone. This is more likely to receive a response from the client and not require additional hassle on behalf of the client.

In Step 210, the behavioral information includes tax professional recommendations. In some instances, the tax professional has an intimate knowledge of the client as well as the client's needs and desires. The tax professional may be therefore invited to recommend certain attributes, discourage certain attributes, provide an analysis of the client, etc.

In Step 212, the behavioral information includes at least a portion of the tax history of the client. As an example, the tax history of the client can influence the technical terms, the subject content, and the tax professional notifications presented. The tax history can include a summary of the tax history, such as tax subjects that have appeared on previous tax returns in the tax history, etc. For example, a client that has filed many previous tax returns reporting rental property income, may be asked questions about rental income. The client interviews are most effective when they are efficient, and as such the tax history may be analyzed in determining attributes.

In Step 214, the behavioral information includes survey results, qualitative information, and other client-derived information. The survey may be presented by the system to the client before the communication strategy is developed. The survey may include questions such as optimal times and locations to contact the client, preferred communication methods for the client, common activities of the client, preferred length and/or number of questions for each client inquiry, devices used by the client, contact information for the client (such as phone numbers and e-mail addresses), and other information that may be helpful in determining attributes for the communication strategy. The survey may also be presented periodically or on demand during the performance of the communication strategy. For example, if the client is repeatedly not responding to the client inquiries, the system may present a survey to the client via e-mail. The survey may ask why the client has been not responding and what the system can do to make the client inquiries easier and more convenient for the client to respond.

In Step 216, the system analyzes device information for the client. In some instances, the device information is derived from the client device that accesses the system, from the survey discussed in Step 214, an indication from the client of the types of devices that they possess and are interested in being associated with the system, etc. Because some attributes, functions, and steps are more and less effective based upon the device platform, the device information may affect the set of recommended attributes. It should be appreciated that the various client devices provide some of the behavioral information, as discussed above such as in Step 206 and Step 208. The behavioral information is related to the determination of when and where to contact the client based upon the information and pattern analysis. The device information is related to the determination of how to contact the client.

In Step 218, the device information includes information indicative of a laptop or desktop computer. Laptop and desktop computers typically provide for the display of more information and faster processors for the computation of data and the presentation of media. In some embodiments, the laptop or desktop computer is utilized as a component of the communication strategy. In other embodiments, the laptop or desktop computer is utilized to setup and/or support the communication strategy. For example, the client may purchase and/or download a home tax preparation program. In order to streamline the process, the home tax preparation program may invite the client to upload various relevant documents, such as Form W2s and Form 1099s. The program may then present the option to the client to utilize the client inquiry system to complete the remainder of the tax interview. Based upon the documents provided, the client inquiries are generated. To further the example, later during the inquiries over text message, the client may give an indication that the client received income from investments. The next time the client utilizes their desktop/laptop, the program may present an option for the client to upload or scan documents related to the investment income. The client is more likely to respond to these simple inquiries than to complete the entire tax interview at one time.

In Step 220, the device information includes information indicative of a tablet computer. Some tablet computers (as well as laptop computers) may have periods without Internet connectivity due to the lack of a mobile broadband connection, which may affect the types of notifications and communication that they can facilitate. The tablet computer may allow for communications with the client through application notifications. However, tablet computers (as well as smart phones discussed below) often include a camera to take a photograph of a document.

In Step 222, the device information includes information indicative of a smart phone. The smart phone is typically the most diverse in being able to receive communication. A typical smart phone can receive phone calls, text messages, and application notifications. This diversity allows the predictive engine and the responsive engine to determine the best way in which to communicate with the client. Further, clients will typically have their smartphone with them most of the time, such that the client can be contacted during their leisure time. The smart phone information (as well as other device information) can include usage statistics, such as screen-on time, active interaction time, call time, texts per day, and other statistics. The smart phone information may also include an indication of a ratio of text messages to phone calls. This may provide an indication as to whether the client prefers to communicate via text message or via a phone call.

In Step 224, the device information includes information indicative of a wearable technology such as a smart watch or the like. Wearable technology typically provides convenience for notifications, but limited computing power, screen size, and Internet access. The wearable technology may be good for presenting and receiving information regarding simple questions. For example, the wearable technology may present questions that invite simple answers (such as “yes/no” or simple numerical answers). The predictive engine may therefore determine the appropriate questions to ask in the client inquiry based upon the device information. The simple questions asked on the wearable technology may be later expanded upon in a phone call or text message that invite more in-depth and longer answers.

In Step 226, the device information includes network information for the client device or devices. The type of network, as well as the bandwidth of the network, may affect the type and size of attributes for the communication strategy. For example, the implementation engine may prevent client inquiries while the client device is connected to a non-secure network. This will prevent the accidental or deliberate interception of the sensitive tax data. In Step 228, the device information includes information related to the operating system of the client device or devices. Certain operating systems may enable certain versions of the software, certain features may be supported by some operating systems but not by others, etc.

In Step 230, the device information may include information indicative of other applications or computer programs present on the client device or devices. The system may interact with, receive information from, or utilize the other applications in the determination of appropriate attributes of the communication strategy. For example, the device information may include information indicative whether the client is engaged in leisurely activity or work-related activity. The implementation engine may allow or specifically contact the client during leisurely activities (such as playing a game) and prevent the client contact during the work-related activity (such as editing a document or writing an e-mail). The implementation engine may also note other applications when determining the appropriate contact method. For example, if the client just hangs up from another phone call or is playing music out loud, the client is probably receptive to receiving a phone call as a phone of communication.

In Step 232, the system determines appropriate attributes for the communication strategy, based upon the behavioral information and the device information. In some embodiments, the system generates a client profile based upon the analysis that includes information indicative of the type of client and/or device. The system determines appropriate attributes by analyzing the available information to make a determination of the attributes and variations thereof that may appeal to the client. Clients contacted via a communication strategy that does not appeal to them are much more likely to fail to respond to the communication strategy. The predictive engine therefore increases the likelihood of interaction with the client by customizing and adapting the communication strategy to a specific client.

In performing Step 232, the system considers the possible attributes in Step 234. Exemplary attributes of an attribute pool are illustrated in FIG. 2. Each attribute may include various levels, versions, types, questions, and contents. The various attributes have been discussed herein. In some instances, within a single client inquiry, questions may be asked such that the latter questions build on the former questions. In other instances, within a single client inquiry, questions may be asked that are independent of one another. Then, subsequent client inquiries may build on the questions from the previous client inquiries.

As another example, the system may analyze that the client is slower to respond on weekends as compared to weekdays. In view of this analysis, the system may adaptively increase or decrease the time between messages on the weekends. Alternatively, the system may analyze that the client is quick to respond to messages sent during a lunch break but slower to respond to messages sent during the work hours. In view of this analysis, the system may adaptively send messages closer to learned “break” times for the client. Yet another example is analyzing that the client reviewed the message on their smart watch. If the client does not respond within a pre-set amount of time, the message may be sent again (based on a pre-set rule that the client quickly reviewed and did not process the need to respond). However, if the client reviewed the message on their tablet, more time for a response may be provided before another message is sent. As should be appreciated, various rules can be created and stored for implementation by the system. The system may also have access to the client's personal and/or business calendar to note meetings, appointments, calls, vacations, out-of-office notes on the client's calendar so that messages are not sent during these hours.

In Step 236, the predictive engine assembles the above-discussed attributes that were selected into a set of recommended attributes. The set of recommended attributes may accompany the client profile discussed above. In Step 238 the predictive engine sends the set of recommended attributes to the implementation engine for communicating with the client.

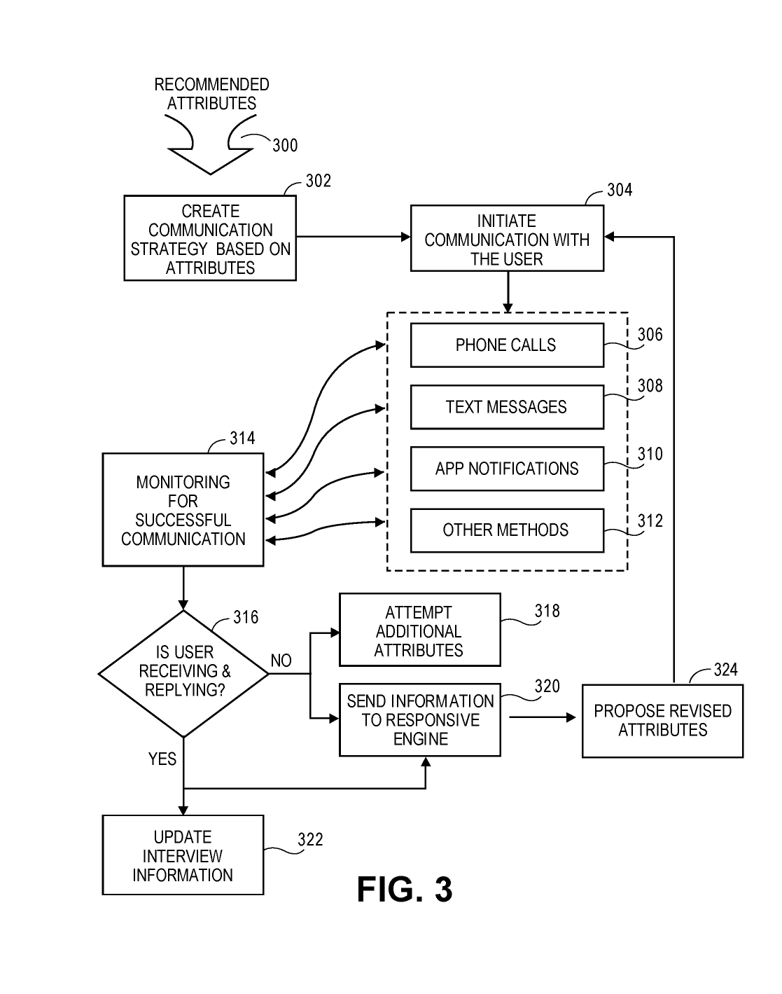

Turning to FIG. 3, attributes for the communication strategy are received, retrieved, or otherwise acquired by the implementation engine in Step 300. It should be noted, referring back to FIG. 1, that the attributes for the communication strategy can be the set of recommended attributes from the predictive engine, the set of revised attributes from the responsive engine, or even a further set of revised attributes from the responsive engine. In many instances, this is a repetitive or even continuous process. For example, based upon location and activity information, the predictive engine and/or the responsive engine may be providing new attributes often. The implementation engine, as illustrated in FIG. 3, initiates and monitors the communication strategy regardless of origin. As with FIG. 2, it should be appreciated that FIG. 3 discusses an embodiment of the invention directed to the field of tax return preparation. This is only an exemplary field and should not be taken as limiting the invention (or the steps discussed in FIG. 3) solely to the field of tax return preparation.

In Step 302, the implementation engine creates or assembles the communication strategy based upon the attributes. In some embodiments, the implementation engine assembles the communication strategy from pre-existing attributes. In other embodiments, the implementation changes attributes in relation to an existing communication strategy. For example, the implementation engine may access a complete communication strategy for persons having the same demographic information as the client. This complete communication strategy may then be supplemented by location and activity information by providing additional attributes about where the client is and what the client is doing.

In Step 304, the implementation engine initiates communication with the client. As discussed throughout, the communication strategy can initiate communication in any combination of devices and interfaces (such as an internet website or smart phone application) at various times and locations. In some instances, a single communication method is utilized so long as the communication is being successful. In other instances, a variety of communication methods are used to determine which way is the most effective for the client and to provide the client with multiple methods of response.

In Step 306, the implementation engine calls a phone associated with the client. The phone call may be to the smart phone or to a land line. In some embodiments, the phone call will be via an automated voice system. The automated voice system will audibly pronounce the questions of the client inquiry. The automated voice system will also hear, record, and/or transcribe the answers provided by the client. In other embodiments, phone call will be via a human operator. For example, the human operator may be presented with few questions of the client inquiry. The human operator will then read the questions to the client and record the responses (such as by typing their answers). The human operator may also ask the client if the client would like to answer additional questions at the end of the client inquiry. The human operator may therefore request additional questions (or such may be presented automatically) to ask the client.

In Step 308, the implementation engine sends text messages. Text messages are typically sent to the smart phone or other cell phone of the client. In some embodiments, the text message may include a single question and invite the client to answer that question. Upon a response (and in some instances, based upon the answer), a second question is presented by text message. Typically, after a few questions the text messages will cease as the client inquiry is completed. The client may additionally or alternatively be sent a text message that thanks the client for their answers and inquires whether the client would like to answer additional questions now. If the client replies that the client does want to continue, an additional client inquiry may be presented to the client over text message. In this way, the client may complete most or all of their tax interview over text message. For example, if the client is in a doctor's office or some other location waiting, the client may be bored and desire to complete the entire tax interview while the client has time.

In other embodiments, the text message may include a link to follow. The link may take the client to an electronic resource, such as a website or an application, to allow the client to answer the questions. This may be done for the entry of sensitive information, such as social security numbers and bank account information that the client would be uncomfortable sending over text message. The system may also remind the client to erase the text messages from their phone upon completion of the client inquiry, such that the information cannot be easily accessed by another.

In Step 310, the implementation engine sends application notifications. While the phone calls and text messages discussed above are typically sent to the smart phone of the client, application notifications may be sent to tablet computers, laptop computers, desktop computers, and wearable technology (in addition to smart phones). The application notification will typically require that the client has downloaded and installed the application on their client device. The application may be the home self-preparation program, a stand-alone application on the smart phone or other device for the tracking and pattern analysis of the client device, a tax interview facilitation application for providing a teleconference with the tax professional, etc. The notification may popup or appear on the screen of the client device and invite the client to click or press on the notification to provide the information. The client may also be allowed to snooze, ignore, or dismiss the notification.

In Step 312, the implementation engine attempts communication by other methods. These other methods may include sending an e-mail. The e-mail may invite the client to respond to the e-mail directly and include the answers to the requested information. Additionally or alternatively, the e-mail may include a link to an electronic resource where the answers may be provided. The implementation engine may also attempt communication by other methods. These could include instant messages via various platforms, such as FACEBOOK and TWITTER. The communication methods could also include an invitation to conduct a teleconference via various platforms, such as FACE TIME and SKYPE. The invitation to teleconference may be in response to a request by the client or an indication that the client does not understand a question. For example, if the client is having trouble answering questions in regard to a certain field or area of their taxes, the implementation engine may invite the client to teleconference with a tax professional to facilitate their understanding without causing frustration or anxiety. The teleconference allows the tax professional to answer questions and alleviate concerns related to the tax return, as well as ask follow up questions to give the tax professional a more complete understanding of the client's situation. For example, there are many complex and nuanced aspects of tax law. In some instances, determine which of these aspects apply to the client may be easier to accomplish over a teleconference.

In embodiments of the invention, some messages are coupled with a request that the client contact a third party, such as the tax professional, a system administrator, or other tax-related person. This request may be based upon unclear or inconsistent answers, requests from the client, and the like. If the client selects a “call now” option, embodiments of the invention facilitate communication between the tax professional and the client. This communication may take several forms, such as a traditional phone call, text message, or internet-based video chat function. The internet-based video chat function can be internal to the system, or link to an external system. Examples of these external systems include SKYPE, FACEBOOK MESSENGER, and GOOGLE HANGOUTS. In embodiments of the invention, the system facilitates communication by opening a new window or display within the application (or by directing the client to the application). In other embodiments of the invention, the system opens an external program or application through which the communication will take place.

Embodiments of the invention provide a snooze function with the message. The snooze function will present another similar message to the client after a certain amount of time. Upon the client selecting the snooze function, some embodiments of the invention present a snooze submenu providing snooze option. The client may select the amount of time in which the client would like to receive a subsequent reminder, such as “5 Minutes,” “10 Minutes,” “1 Hour,” and “Try Again Tomorrow.”

In Step 314, embodiments of the invention receive, analyze, and track data indicative of responses or lack of responses from the client based upon the various contact methods utilized. While the client is not expected to provide perfect responses, the implementation engine denotes when client inquiries were attempted and when responses were received.

In some embodiments of the invention, the data that is received is associated with the client's account so that it can be tracked and analyzed over time. In some embodiments of the invention, the data is also associated with the tax professional's account so the tax professional can monitor the responses to the communication strategy. In other embodiments of the invention, the tax professional has access to all or a summary of the data associated with the client's account. In yet further embodiments, there is no human tax professional associated with the client.

In Step 316, the system determines whether the client is adequately responding to the communication strategy. The determination may be based upon a fixed threshold, a variable threshold, an average of response over time, or the like. If the client is not adequately responding, the communication strategy may cease or present to the client an option to no longer participate in the communication strategy. The client may select to perform a more traditional inquiry, such as an in-person tax interview, a tax interview via a teleconference, completing their taxing via a home tax preparation program, or the like. The client may also be presented with a survey, as discussed above in Step 214, to determine if there are better ways to communicate with the client and to receive information as to why the client has not been responding.

In Step 318, the implementation engine may attempt to communicate via additional attributes in the communication strategy. As discussed above, the communication strategy will typically include many attributes as far as recommended times, locations, and methods of contacting the client. If the client has been failing to respond, the implementation engine may attempt other methods that were in the set of recommended attributes (as discussed in FIG. 1). The implementation engine may also attempt different combinations of attributes.

In Step 320, the system sends information to the responsive engine for further analysis. As can be seen in FIG. 3, Step 320 is performed if the client is responding and if the client is not responding. This is because the system attempts to improve responses, even if the client is responding adequately. This keeps the communication strategy from becoming stagnant and boring. However, upon the analysis of the responsive engine, the set of revised attributes may not change from the set of attributes currently being used (or may be changed only slightly).

If the client is responding to the client inquiries, in Step 322 the tax interview information is updated. In embodiments of the invention, the tax interview information is the same or substantially similar to the interview log discussed above in Step 110. The tax interview information is used by the computer program or a tax professional to prepare the tax return. The tax interview information may also indicate what further questions need to be answered in follow up to the answers given thus far by the client. For example, if the client indicates that they have income from investments, the tax interview information is updated with this information. The implementation engine may then ask additional, follow-on questions related to the investment income. In some instances, the computer program may already know about the investment income because the client has previously entered or scanned documents related to the investment income (such as a Form 1099). The answers will thereafter be entered into the tax interview information.

In some embodiments, once the tax interview information is complete (as shown in Step 112), the tax interview information may be sent or made available to a tax professional for preparation of the tax return. In these embodiments, the tax professional may find discrepancies or errors in the responses and present additional client inquiries (or directly call or otherwise contact the client).

In Step 324, the responsive engine analyzes the available information to determine potential reasons for non-response (if applicable) and recommend revised attributes. For example, if the client rarely uses their smart phone, the reason for non-response may be a failure of the system to provide messages that reach the client. The recommended revised attributes may then include calling a land line or sending an e-mail. As another example, if the client often answers with a response indicative that they do not know the answer or understand the question, the verbiage level or technical terms level of the question may be too high for the client, and the client may be failing to respond out of frustration.

The responsive engine may also analyze prior attribute changes recommended by previous iterations of the responsive engine. As best illustrated in FIG. 1, in embodiments of the invention the responsive engine and implementation engine run in a loop. After the set of revised attributes is sent to the implementation engine in Step 116, the revised communication strategy is again utilized to attempt communication with the client in Step 108.

The responsive engine may also consider at least a portion of, substantially all, or all of the previously-utilized attributes. The responsive engine may also consider previous iterations of the response information. For example, the responsive engine may consider how the set of revised attributes changed the interaction level. This consideration gives additional insight into how the attributes affect the interaction with the client and allows the responsive engine to continuously improve. In some embodiments, the responsive engine compares the response information to sets of attributes that have been effective for other comparable clients in the past or concurrently (such as by analyzing the client characteristics and demographics, as discussed above in Steps 202 and 204, respectively). If the client shares characteristics with another client that was previously failing to respond, the responsive engine may analyze how the non-responses were overcome for that other client.

The responsive engine assembles the attributes likely to improve response into a set of revised attributes. As discussed above, some attributes may remain unchanged, some attributes may be changed (e.g. moved to another level), some attributes may be deleted, and some attributes may be added (e.g. adding a game component). In some embodiments, the set of revised attributes is a complete set of all attributes in the set. In other embodiments, the set of revised attributes is a list of the changes, additions, and deletions to the set of attributes currently being utilized by the implementation engine.

The responsive engine sends the set of revised attributes to the implementation engine such that the revised communication strategy may be implemented in Step 304. Typically, the revised communication strategy is implemented without notifying the client of the changes. In some embodiments, the implementation engine decides which of the above-discussed implementation methods to use based on the number and type of changes as a whole (as discussed above). For example, if the revised communication strategy has no changes or only minimal changes, the implementation engine may implement the changes without notifying the client. If the revised communication strategy is drastically changed, the implementation engine may present a message to the client explaining the proposed changes, recommending implementation, and presenting the client with an option to agree.

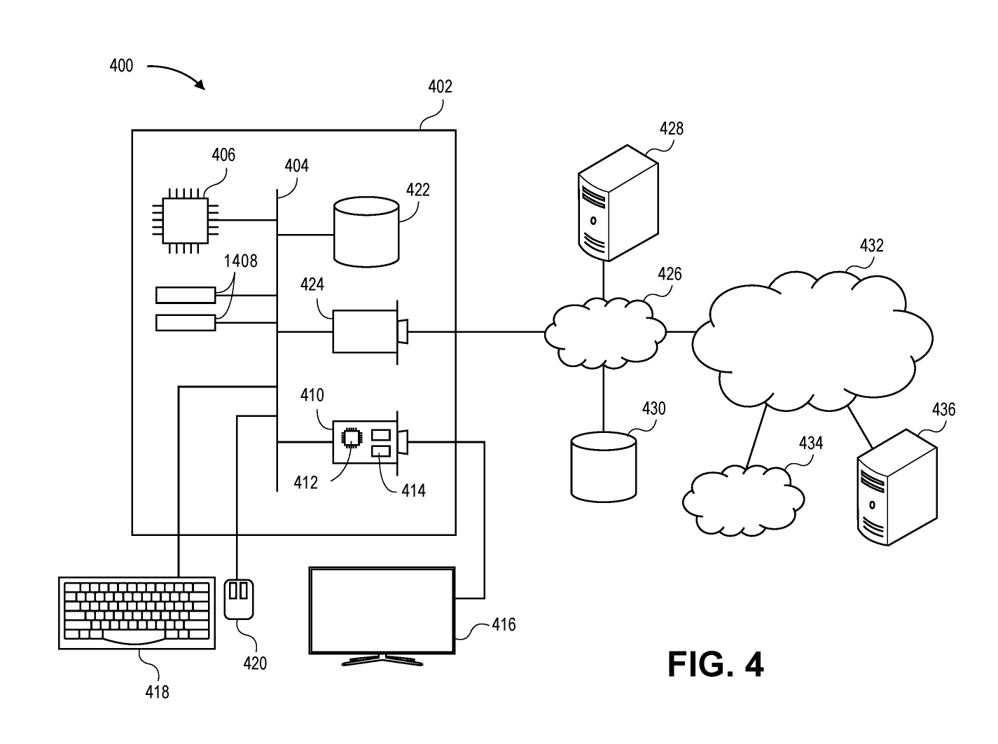

Turning to FIG. 4, the physical hardware that makes up the system will now be discussed. The system 400 comprising an exemplary hardware platform that can form one element of certain embodiments of the invention is depicted. Computer 402 can be a desktop computer, a laptop computer, a server computer, a mobile device such as a smartphone or tablet, or any other form factor of general- or special-purpose computing device. Depicted with computer 402 are several components, for illustrative purposes. In some embodiments, certain components may be arranged differently or absent. Additional components may also be present. Included in computer 402 is system bus 404, whereby other components of computer 402 can communicate with each other. In certain embodiments, there may be multiple busses or components may communicate with each other directly. Connected to system bus 404 is central processing unit (CPU) 406. Also attached to system bus 404 are one or more random-access memory (RAM) modules 408.

Also attached to system bus 404 is graphics card 410. In some embodiments, graphics card 404 may not be a physically separate card, but rather may be integrated into the motherboard or the CPU 406. In some embodiments, graphics card 410 has a separate graphics-processing unit (GPU) 412, which can be used for graphics processing or for general purpose computing (GPGPU). Also on graphics card 410 is GPU memory 414. Connected (directly or indirectly) to graphics card 410 is display 416 for client interaction. In some embodiments no display is present, while in others it is integrated into computer 402. Similarly, peripherals such as keyboard 418 and mouse 420 are connected to system bus 404. Like display 416, these peripherals may be integrated into computer 402 or absent. Also connected to system bus 404 is local storage 422, which may be any form of computer-readable media, and may be internally installed in computer 402 or externally and removably attached.

Finally, network interface card (NIC) 424 is also attached to system bus 404 and allows computer 402 to communicate over a network such as network 426. NIC 424 can be any form of network interface known in the art, such as Ethernet, ATM, fiber, Bluetooth, or Wi-Fi (i.e., the IEEE 802.11 family of standards). NIC 424 connects computer 402 to local network 426, which may also include one or more other computers, such as computer 428, and network storage, such as data store 430. Local network 426 is in turn connected to Internet 432, which connects many networks such as local network 426, remote network 434 or directly attached computers such as computer 436. In some embodiments, computer 402 can itself be directly connected to Internet 432.

The computer program of embodiments of the invention comprises a plurality of code segments executable by a computing device for performing the steps of various methods of the invention. The steps of the method may be performed in the order described, or they may be performed in a different order, unless otherwise expressly stated. Furthermore, some steps may be performed concurrently as opposed to sequentially. Also, some steps may be optional. The computer program may also execute additional steps not described herein. The computer program, system, and method of embodiments of the invention may be implemented in hardware, software, firmware, or combinations thereof using a client inquiry system, which broadly comprises server devices, computing devices, and a communications network.

The computer program of embodiments of the invention may be responsive to client input. As defined herein client input may be received from a variety of computing devices including but not limited to the following: desktops, laptops, calculators, telephones, smartphones, or tablets. The computing devices may receive client input from a variety of sources including but not limited to the following: keyboards, keypads, mice, trackpads, trackballs, pen-input devices, printers, scanners, facsimile, touchscreens, network transmissions, verbal/vocal commands, gestures, button presses or the like.

The server devices and computing devices may include any device, component, or equipment with a processing element and associated memory elements. The processing element may implement operating systems, and may be capable of executing the computer program, which is also generally known as instructions, commands, software code, executables, applications (“apps”), and the like. The processing element may include processors, microprocessors, microcontrollers, field programmable gate arrays, and the like, or combinations thereof. The memory elements may be capable of storing or retaining the computer program and may also store data, typically binary data, including text, databases, graphics, audio, video, combinations thereof, and the like. The memory elements may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), and the like, or combinations thereof. In addition to these memory elements, the server devices may further include file stores comprising a plurality of hard disk drives, network attached storage, or a separate storage network.

The computing devices may specifically include mobile communication devices (including wireless devices), work stations, desktop computers, laptop computers, palmtop computers, tablet computers, portable digital assistants (PDA), smart phones, smart watches, other smart wearables, and the like, or combinations thereof. Various embodiments of the computing device may also include voice communication devices, such as cell phones and/or smart phones. In some embodiments, the computing device will have an electronic display operable to display visual graphics, images, text, etc. In certain embodiments, the computer program facilitates interaction and communication through a graphical client interface (GUI) that is displayed via the electronic display. The GUI enables the client to interact with the electronic display by touching or pointing at display areas to provide information to the system.

The communications network may be wired or wireless and may include servers, routers, switches, wireless receivers and transmitters, and the like, as well as electrically conductive cables or optical cables. The communications network may also include local, metro, or wide area networks, as well as the Internet, or other cloud networks. Furthermore, the communications network may include cellular or mobile phone networks, as well as landline phone networks, public switched telephone networks, fiber optic networks, or the like.

The computer program may run on computing devices or, alternatively, may run on one or more server devices. In certain embodiments of the invention, the computer program may be embodied in a stand-alone computer program (i.e., an “app”) downloaded on a client's computing device or in a web-accessible program that is accessible by the client's computing device via the communications network. As used herein, the stand-along computer program or web-accessible program provides clients with access to an electronic resource from which the clients can interact with various embodiments of the invention.

In embodiments of the invention clients may be provided with different types of accounts. Each type of client account may provide their respective clients with unique roles, capabilities, and permissions with respect to implementing embodiments of the invention. For instance, a tax professional may be provided with a tax professional account that permits the tax professional to access embodiments of the invention that are applicable to the tax professional managing the tax return preparation of multiple clients. Additionally, a client may be provided with a client account that permits the client to access embodiments of the invention that are applicable to managing their own communication strategy. In addition, any number and/or any specific types of accounts is provided as may be necessary to carry out the functions, features, and/or implementations of the invention. Upon a tax professional or client logging in to the electronic resource for a first time, the tax professional or client may be required to provide various items of identification information to create their respective accounts. Such identification information may include, for instance, personal name, business name, email address, phone number, or the like. Upon providing the identification information, the client may be required to enter (or may be given) a username and password, which will be required to access the electronic resource.

Execution of the computer program of embodiments of the invention performs steps of the method of embodiments of the invention. Because multiple clients may be updating information stored, displayed, and acted upon by the computer program, information displayed by the computer program is displayed in real-time. “Real-time” as defined herein is when the processing element of the system 10 performs the steps less than every 1 second, every 500 milliseconds, every 100 milliseconds, or every 16 milliseconds.

The method of embodiments of the invention for providing the GUI broadly comprises the following steps: accepting client input, updating information in response to client input, providing an updated GUI. Initialization of the computer program by a client, as may occur when a new client begins to use the system, includes the following additional steps: prompting for the client login, retrieving the credentials input by the client, and determining the first screen of the GUI to provide to the client. Additional steps are also performed if the client has never used the system before, namely prompting the client to create a login and verifying the login is available.

The method of embodiments of the invention for providing the secondary GUI broadly comprises the following steps: accepting client input, updating information in response to client input, and providing an updated GUI. Each time the client opens the computer program comprises the following additional steps: verifying the credentials of the client, determining the first screen of the GUI to provide to the client. The secondary GUI is deployed in response to the message sent to the client so creating a login does not need to be performed.

Although embodiments of the invention have been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A computerized method for gathering information from a client, the method comprising the following steps:
acquiring a set of behavioral information for the client;
acquiring a set of device information related to a client device associated with the client;
generating a set of recommended attributes based upon the behavioral information and the device information;
generating a first client inquiry based upon the set of recommended attributes;
sending the first client inquiry to the client via the client device,
analyzing a client response to the first client inquiry,
refining, based upon the client response to the client inquiry, said behavioral information for the client;
generating a set of revised attributes based upon the set of recommended attributes and said refined behavioral information; and
sending a second client inquiry to the client via the client device,
wherein the second client inquiry is based upon the set of revised attributes.

2. The computerized method of claim 1,
wherein the set of behavioral information includes information as to client characteristics known about the client,
wherein the set of behavioral information includes information as to demographics of the client.

3. The computerized method of claim 1,
wherein the set of behavioral information includes geographic information from the client device related to a location of the client,
wherein the set of behavioral information includes movement information from the client device.

4. The computerized method of claim 1,
wherein the set of device information includes information related to a smart phone of the client,
wherein the smart phone is configured to receive phone calls, text messages, and application notifications.

5. The computerized method of claim 1, wherein at least one of the behavioral information and the device information include a pattern analysis to determine habitual behaviors of the client.

6. The computerized method of claim 1,
wherein the client inquiry includes a set of questions for the client to answer,
wherein at least one latter question is based upon the response to a former question.

7. The computerized method of claim 1,
wherein said sending the first client inquiry to the client via the client device is performed by calling the client with an automated phone call,
wherein said client response is received by transcribing spoken answers from the client.

8. The computerized method of claim 1,
wherein said sending the first client inquiry to the client via the client device is performed by sending a text message,
wherein said client response is received via a responding text message.

9. The computerized method of claim 1,
wherein said sending the first client inquiry to the client via the client device is performed by sending an e-mail that includes a link to an electronic resource,
wherein said client response is received via the input of information into the electronic resource.

10. The computerized method of claim 1, wherein said client response is characterized as belonging to the set comprising receiving no response from the client, receiving the requested information as well as behavioral information from the client, receiving an incomplete response from the client, receiving a complete but factually inaccurate response from the client, and receiving a request for help from the client.

11. The computerized method of claim 1,
wherein the first client inquiry is sent to the client device at a first time in a first location,
wherein the second client inquiry is sent to a second client device at a second time in a second location.

12. The computerized method of claim 1,
wherein the client is a taxpayer,
wherein the communication strategy is associated with a tax interview,
wherein the client inquiry is associated with the preparation of a tax return on behalf of the taxpayer.

13. A client inquiry system, the system comprising:
a predictive engine for developing a set of recommended attributes,
wherein the set of recommended attributes is based upon behavioral information and device information related to a client;
an implementation engine for sending a first client inquiry to the client via a client device,
wherein the first client inquiry is based at least in part on the set of recommended attributes of the communication strategy; and
a responsive engine for analyzing whether the client responded to the first client inquiry,
said responsive engine refining the set of recommended attributes to form a set of revised attributes,
wherein the set of revised attributes is configured to improve client responses,
wherein the implementation engine sends a second client inquiry based at least in part on the set of revised attributes.

14. The client inquiry system of claim 13, wherein the predictive engine acquires a set of behavioral information and a set of device information.

15. The client inquiry system of claim 14,
wherein the set of behavioral information includes geographic information from the client device related to a location of the client,
wherein the set of behavioral information includes movement information from the client device.

16. The client inquiry system of claim 14,
wherein the set of device information includes information related to a smart phone of the client,
wherein the smart phone is configured to receive phone calls, text messages, and application notifications.

17. The client inquiry system of claim 14,
wherein the implementation engine sends the first client inquiry by providing an automated telephone call to the client device,
wherein the implementation engine sends the second client inquiry by providing a text message to the client device,
wherein the implementation engine sends a third client inquiry by providing an application notification to the client device.

18. The client inquiry system of claim 13,
wherein the set of recommended attributes and the set of revised attributes are designed to contact the client while the client is otherwise available and unoccupied,
wherein the set of recommended attributes and the set of revised attributes are based at least in part on a pattern analysis to determine where the client is and what the client is doing,
wherein, based upon where the client is and what the client is doing, the set of recommended attributes and the set of revised attributes are configured to communicate with the client in a manner that is convenient for the client.

19. A client inquiry system comprising:
a predictive engine configured to perform steps including—
acquiring a set of behavioral information;
acquiring a set of device information related to a client device associated with the client;
determining a set of recommended attributes based upon said set of behavioral information and said set of device information;
an implementation engine configured to perform steps including—
sending a first client inquiry to the client via the client device,
wherein the first client inquiry is based at least in part on the set of recommended attributes;
analyzing a client response to the first client inquiry; and
a responsive engine configured to perform steps including—
refining, based upon the client response to the client inquiry, the set of recommended attributes to form a set of revised attributes;
sending the set of revised attributes to the implementation engine,
wherein the implementation engine sends a second client inquiry to the client via the client device,
wherein the second client inquiry is based upon the set of revised attributes.

20. The client inquiry system of claim 19,
wherein the set of recommended attributes and the set of revised attributes are designed to contact the client while the client is otherwise available and unoccupied,
wherein the set of recommended attributes and the set of revised attributes are based at least in part on a pattern analysis to determine where the client is and what the client is doing,
wherein, based upon where the client is and what the client is doing, the set of recommended attributes and the set of revised attributes are configured to communicate with the client in a manner that is convenient for the client.
